(19) United States
(12) Patent Application Publication
(10) Pub. No.: US 2015/0310749 A1
(43) Pub. Date: Oct. 29, 2015

(54) Apparatus and Method for Emergency Response Preparedness

(71) Applicant: Patrick J. Sergott, Johns Island, SC (US)

(72) Inventor: Patrick J. Sergott, Johns Island, SC (US)

(21) Appl. No.: 14/261,869

(22) Filed: Apr. 25, 2014

(51) Int. Cl. G09B 5/00; G09B 19/00

(52) U.S. Cl. CPC G09B 5/00; G09B 19/00

(57) ABSTRACT

An apparatus and method for computer aided emergency response preparedness wherein content of training material and related documentation presented to a client staff member engaged in interactive training is tailored to the client staff member in accordance with information stored in a database characterizing client organizations, client facilities and client staff members. Advantageously, interactive sessions are supported for data collection and training via a communication network such as the Internet. Facilities are provided for interactive creation and modification of content of training material and related documentation and for client account creation by provider specialists whereby credentials are established for enabling interactive sessions by client staff members.

### I. BACKGROUND OF THE INVENTION

1. Field of the Invention

This invention relates generally to preparation for emergency responses to be undertaken within a particular facility. In particular, this invention relates to interactive tools for computer-aided emergency response planning and training.

2. Description of Related Art

Emergency response planning is a common practice for emergency preparedness, i.e., preparing to respond to events posing a threat to safety of persons and property. Emergency response planning advantageously contemplates emergency responses applicable to particular facilities and can include evacuation (movement of occupants from a structure to a location protected from an event affecting the structure), displacement (movement of occupants of an assembly area to an alternate location protected from an event threatening the assembly area, shelter-in-place (also referred to as severe weather response; assumption by occupants within a location of positions providing shelter from an event affecting the location not requiring lockdown or evacuation), lockdown (activation of security devices to prevent access to occupied locations within a structure) and violent intruder response (verbally and/or physically controlling adversarial or threatening behavior of a person or persons within a facility). For each emergency plan response, it is advantageous to define a predetermined set of “roles” for organization staff members, each “role” having an associated set of responsibilities to prepare for and execute a particular emergency response. In essence, an emergency response plan comprises categories of responses, preparedness activities, response preparation activities and response actions. Emergency response planning for organization facilities used by organization staffs, guests and the general public typically includes planning specific to those facilities. An organization facility may encompass a combination of grounds and structures making up an organization site, for example, a campus of a: school, hospital, residential and/or business park, governmental agency or other government operated installation. Hence, facility specific planning accommodates the structures and grounds at a particular site as well as natural and man-made boundaries that have a bearing on emergency response actions. Emergency response training is a key element of emergency response preparedness. Training is aimed at familiarizing organization staff members with the categories of emergency responses comprising an organization plan and particulars of emergency response preparation and execution to be undertaken when the need arises.

There exists an increasing demand for organizations to improve their preparedness for events that threaten injury to occupants of a facility whether those events are naturally occurring or caused by deliberate or negligent acts. Governments are moving to requiring public institutions to prepare emergency response plans and to train members of their organizations according to those plans. Likewise, many private organizations, responding to recognition of risks to their personnel and the public that use their facilities, have a growing interest in improving their emergency preparedness. In general, other than organizations that are engaged in responding to emergencies and providing security for facilities, organizations that have a need for emergency response planning and training do not have sufficient personnel with the needed expertise, experience and availability to satisfy those needs. Hence, there is a growing demand by private and public organizations for assistance with emergency response planning and training. While it is known to provide computer based facilities for assisting users with plan preparation and to provide computer based training materials, for the most part, known plan preparation and training products are deficient in supporting adaptation to particulars of an organization, its staff and its facilities. Consequently, organizations are driven to having customized planning and training undertaken by qualified service providers with attendant relatively high costs in both money and staff time. Hence, there remains a need for improved products to facilitate emergency response planning and training tailored to particular organizations, their staffs and facilities that can be delivered with relatively low funding costs and little disruption to staff schedules.

### SUMMARY OF THE INVENTION

It is an object of the present invention to provide an apparatus and method for computer aided emergency response preparedness wherein content of training material and related documentation presented to a client staff member engaged in interactive training is tailored to the client staff member in accordance with information stored in a database characterizing client organizations, client facilities and client staff members.

Further objects and advantages of the invention shall be made apparent from the accompanying drawings and the following description thereof.

In accordance with the aforesaid objects the present invention provides an apparatus for emergency response preparedness comprising at least one program controlled device comprising: a display device with associated data entry device and pointing device, a data processor and memory; operating programs stored in the memory for controlling operation of components of the program controlled device and controlling execution of application programs; database application programs for program controlled management of a database of stored information for characterizing client organizations, client facilities, and client staff members; emergency response preparedness application programs for computer aided: collection of information to be stored in the database; interactive emergency response training; and interactive creation of content of emergency response training material and related documentation wherein content of training material and related documentation presented to a client staff member engaged in interactive training is tailored to the client staff member in accordance with information stored in the database. A method in accordance with the invention provides execution of database application programs for program controlled management of a database of stored information characterizing client organizations, client facilities and client staff members; and execution of emergency response preparedness application programs for computer aided: collection of information to be stored in the database; interactive emergency response training; and interactive creation of content of emergency response training material and related documentation wherein content of training material and related documentation presented to a client staff member engaged in interactive training is tailored to the client staff member in accordance with information stored in the database.

### BRIEF DESCRIPTION OF THE SEVERAL VIEWS OF THE DRAWING

FIG. 1 is a block diagram showing programmed controlled devices and their interconnection in accordance with the invention.

FIGS. 2A-2E illustrate a template of a display presented to a provider staff member (hereinafter, “provider specialist”) while engaged in an interactive session for emergency preparedness.

FIGS. 3A-3F illustrate a template of a display presented to a user identified as a client organization staff member while engaged in an interactive session for emergency preparedness.

FIGS. 4A and 4B illustrate procedures implemented by execution of programs in accordance with the invention for effecting data collection by users identified as provider specialists and client organization staff members.

FIGS. 5A-5E Illustrate displays presented to provider specialists for creating and revising content of material to be used by client organizations.

FIGS. 6A-6F illustrate displays presented to client organization staff members for use in interactive training.

FIG. 7 illustrates procedures implemented by execution of programs in accordance with the invention for effecting interactive training.

### DETAILED DESCRIPTION OF THE PREFERRED EMBODIMENT

The invention shall be illustrated with reference to a preferred embodiment which shall be described in detail. It is not the intention of applicant that the invention be limited to the preferred embodiment, but rather that the invention shall be defined by the appended claims and all equivalents thereof. As used herein: the term “client organization” refers to an organization that subscribes to services for emergency preparedness enabled by the invention; the terms “client organization staff member” and “client staff member” (used interchangeably) refer to a member of a client organization irrespective of the position of that member within that organization; the term “provider” refers to the proprietor of services for emergency preparedness enabled by the invention; the term “provider organization” refers to the organization of the provider of those services and, the term “provider specialist” refers to a member of that organization.

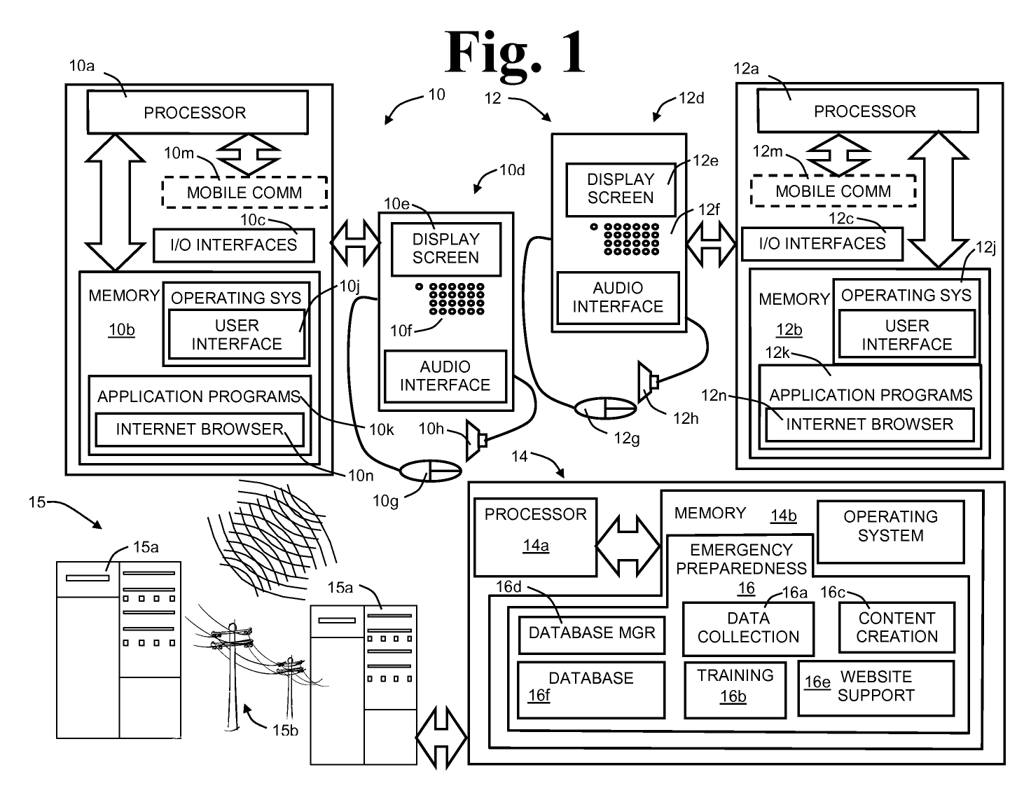

A preferred embodiment of apparatus for practicing the invention shall be described with reference to the block diagram of FIG. 1. Program controlled devices such as client user device 10 and provider user device 12 communicate with server 14 via digital communication network 15 including, for example, radio transmission and receiver device(s) 15a and cabled signal carriers such as cable lines 15b. Digital communications network 15 advantageously comprises interconnected networks such as the so-called Internet for which there are known protocols for data exchanges between connected devices. Client user device 10 and provider user device 12 are substantially the same. Client user device 10 comprises a mass data storage device 10b comprising re-writable non-volatile memory such as magnetic disk memory or electronic “flash” memory, at least one processor 10a, and input/output interfaces 10c for connection of peripheral equipment such as client user interface device 10d and scanning and printing devices (not shown). Advantageously, client user interface device 10d comprises, a display screen 10e, keyboard or keypad (used interchangeably herein) 10f, pointer device 10g such as a so-called “mouse” and audio device(s) such as speaker 10h. While processor 10a is illustrated as a single element, as used in this description and the appended claims, “processor 10a” or “processor” shall be deemed to represent one or more program controlled microprocessors and so-called “co-processors”, and the like, for executing programs stored in memory. While only mass storage device 10b is illustrated, client user device 10 advantageously comprises additional memory (not shown) such as read-only memory used for storage of so called binary operating system programs (BIOS) for controlling operation of processor 10a. Client user device 10 may advantageously comprise a mobile communication element 10m for providing wireless communication including, for example, cellular radio communication and so-called “WIFI” communication whereby digital data is transmitted and received by radio signals between client user device 10 and a radio relay device intermediate client user device 10 and communication equipment 15. It is to be understood that whether or not client user device 10 includes any type of wireless communication device, communication equipment 15 typically comprises both wireless (radio) and cabled channels of communication. Hence, client user device 10 may make use of a “wired” connection to a communication provider and that communication provider may include wireless communication within communication networks that it provides. Client user device 10 can comprise commercially available: personal computers; so-called “smart phones” (enhanced feature cellular telephone devices): and, so-called “tablets” (portable all-in-one program controlled devices relying on wireless communication). While client user interface device 10d is illustrated as comprising separate display 10e and keyboard 10f, an alternative interface device may combine the display and keyboard into a single device having a touch sensitive layer overlying at least a portion of a display device as is known for enhanced feature cellular telephones and for tablets.

Continuing with reference to FIG. 1, provider user device 12 comprises a mass data storage device 12b comprising re-writable non-volatile memory such as magnetic disk memory or electronic “flash” memory, at least one processor 12a, and input/output interfaces 12c for connection of peripheral equipment including for example user interface devices, such as user interface device 12d, and document scanning and printing devices (not shown).

Advantageously, provider user interface device 12d comprises, for example, a display screen 12e, keyboard or keypad (used interchangeably herein) 12f, pointer device 12g such as a so-called “mouse” and audio device(s) such as speaker 12h. While processor 12a is illustrated as a single element, as used in this description and the appended claims, “processor 12a” or “processor” shall be deemed to represent one or more program controlled microprocessors and so-called “co-processors”, and the like, for executing programs stored in memory. While only mass storage device 12b is illustrated, provider user device 12 advantageously comprises additional memory (not shown) such as read-only memory used for storage of so called binary operating system programs (BIOS) for controlling operation of processor 12a. Provider user device 12 may advantageously comprise a mobile communication element 12m for providing wireless communication including, for example, cellular radio communication and so-called “WIFI” communication whereby digital data is transmitted and received by radio signals between provider user device 12 and a radio relay device intermediate provider user device 12 and communication network 15. It is to be understood that whether or not provider user device 12 includes any type of wireless communication device, communication network 15 typically comprises both wireless (radio) and cabled channels of communication. Hence, provider user device 12 may make use of a “wired” connection to a communication provider and that communication provider may include wireless communication within communication networks that it provides. Provider user device 12 can comprise commercially available: personal computers; so-called “smart phones” (enhanced feature cellular telephone devices): and, so-called “tablets” (portable all-in-one program controlled devices relying on wireless communication). While provider user interface device 12d is illustrated as comprising separate display 12e and keyboard 12f, an alternative interface device may combine the display and keyboard into a single device having a touch sensitive layer overlying at least a portion of a display device as is known for enhanced feature cellular telephones and for tablets.

Continuing with reference to FIG. 1, server 14 is a program controlled device accessed by client users and provider users solely by a digital communications network such as communications network 15. Server 14 comprises program controlled processor 14a and a mass data storage device 14b comprising re-writable non-volatile memory such as magnetic disk memory or electronic “flash” memory. While an operator of server facilities may have user interface devices for connection to its servers, such devices are not used by either client users or provider users and are not shown in FIG. 1. Server 14 is the preferred platform for programs that implement functionality of the present invention and for storage of data that are used with those programs to provide client users improved emergency response planning and training in accordance with the invention. It is not necessary that data or programs reside on a server accessible solely via a communications network. Rather, programs and data implementing the invention could reside on program controlled devices totally within the control of the provider.

As is conventional, data processing functions performed by client user device 10 are controlled by operating system programs such as operating system programs 10j that control execution of so-called “application programs” by processor 10a. A subset of operating system programs 10j are user interface programs 10k that control operation of the client user interface devices in accordance with the capabilities of the devices comprising client user device 10. In a like manner, user interface programs 12k of operating system programs 12j of provider user device 12 control operation of the provider user interface devices. For purposes of the preferred embodiment, the only “application program” of interest is a so-called “browser” program 10n that effects communication via the Internet. The browser supports identification of and communication through the server internet address to access the provider's internet accessible facility, i.e., the provider “web site”. Information collection, user training and documentation generation are all achieved, in whole or in part through the provider web site. In a like manner, “browser” program 12n of application programs 12k of provider user device 12. In the preferred embodiment, server 14 executes application programs resident on server 14 to generate display content to be presented on client user interface device 10d and on provider user interface device 12d in response to user selections and entries originated at the user interface device so as to achieve interactive operation contemplated by the present invention.

The present invention is directed to computer aided emergency response planning and training wherein information particular to facilities and staff members of client organizations is collected to provide tailored planning and training for a variety of emergency responses. In general, planning contemplates predetermined responses for events that pose risks to health and safety of users of organization facilities. Planning and training are provided for response actions including evacuation, shelter-in-place, displacement, lockdown and violent intruder response. The invention relies on collaboration between provider specialists and staff of the client organization to “build” a database of information useful to training client organization staff to execute response actions specific to their emergency response role and to their location in an organization facility. Training is effected through interactive computer-aided sessions where a client organization staff member uses a program controlled device such as client user device 10 to communicate with server 14. Server 14 supports interaction with client user device 10 and provider user device 12 by execution of emergency preparedness programs 16 and website support programs 16e providing support for operation of a “website” established by the provider and for enabling receipt and transmission of information via an internet service provider. As illustrated in FIG. 1, emergency preparedness programs 16 are characterized by components comprising: data collection component 16a for effecting collaborative collection of data pertinent to the user facility, client staff members and client staff member roles; training component 16b for effecting interactive progress through training sessions of client staff members; content creation component 16c for supporting creation of content of training material and of supplementary documentation pertaining to emergency response, for example emergency response action checklists that are tailored to a particular emergency event, facility and staff member role; and, data management component 16d comprising database management programs for defining organization and relationships of information in the database and for supporting queries to retrieve information from the database.

The following descriptions illustrate the foregoing aspects of the invention with reference to the accompanying drawings. As used herein, the term “select” used in connection with actions performed by a client staff member or provider specialist during an interactive computer session refers to the conventional use of a pointing device, such as pointing devices 10g and 12g to place a display cursor over an item being displayed and operate a switch of the pointing device to indicate that item is being chosen by the staff member or provider specialist. As used herein and in the appended claims “audio/video information” will refer to audio information only, video information only and the combination of audio and video information. As used herein and in the appended claims “presentation” of audio/video information shall refer to the production of sound in response to audio information, the display of images in response to video information and, as applicable, the combination of production of sound and display of images.

Website support programs 16e of emergency preparedness programs 16 are advantageously written using Hypertext Markup Language (“HTML”) to effect presentation of webpage content by internet browser programs such as internet browser 10n of client user device 10 and internet browser 12n of provider user device 12. Programs written with HTML support presentation of text, images and graphic objects and definition of interactive forms. Facilities of browser programs 10n and 12n support local processing of groupings, for example “pages”, of information received from server 14 so as to allow local generation of updated displays according to user actions and content comprising a grouping of information. For example, as user entries are made from a keypad, browser programs 10n and 12n are effect to echo the keypad entries in the display presented. Likewise, where a user selection is associated with presentation of a “drop-down” menu or “pop-up” panel, browser programs 10n and 12n are effective to process grouping (“page”) information to effect presentation of the “drop-down” menu or “pop-up” panel from information received without further communication with server 14. References herein to updating of presentations by emergency preparedness programs 16, contemplate the totality of local processing by browser programs such as internet browsers 10n and 12n and the reliance of those programs upon “pages” of information supplied by emergency preparedness programs 16 following login of a credentialed user and user initiation of a desired activity to achieve displays of desired content in presentations at display devices such as display screens 10e and 12e. Once user action reflects that the results of entries and selections are to be recorded, for example by operation of an active display such as a “submit” button, information is transferred under control of browser 10n or 12n, as the case may be, to server 14 for processing by emergency preparedness programming 16. Where results of user entries and selections are associated with data to be contained in database 16f, emergency preparedness programming 16 effects writing of the appropriate data to database 16f. The database manager programs of server 14 advantageously comprise a relational database management system such as MySQL (Open Source) that facilitates definition of the organization of information and relationships among categories of information contained in a database. In a MySQL database management system operated database, data is organized in tables and relationships of table data facilitates entry and retrieval of data from plural tables using statements relying on underlying data relationships. Advantageously, statements processed by the database management system comprise so-called Structured Query Language (“SQL”) statements to effect writing information to the database and retrieving information from the database. The required SQL statements are generated by execution of so-called “scripts” written using Hypertext PreProcessor language (“PHP”). User entries and selections from user interface devices are supported by use of HTML interactive forms effective for presenting information retrieved from and to be written to the database. PHP scripts receive information from the HTML for writing to the database and provide information to the HTML for presentations displayed on user interface device 10d.

### Interactive Sessions

The invention contemplates interactive sessions by both client staff members and provider specialists wherein facilities of emergency preparedness programs 16 enable credentialing of users and enable use of the emergency preparedness programs by credentialed users in a computer aided interactive environment. As used herein, “interactive” refers to presentation of material to, and recognition of associated responses effected from, an operator interface device such as user interface device 10d and provider interface device 12d. Presentation of material may comprise visual displays and audible sounds and associated response may comprise keyboard entries and selections from choices presented using, for example, a pointing device. In general, emergency preparedness programs 16 are effective to process user responses so as to affect material being presented, by, for example updating content of material being presented or by presenting other material.

### Provider Specialists

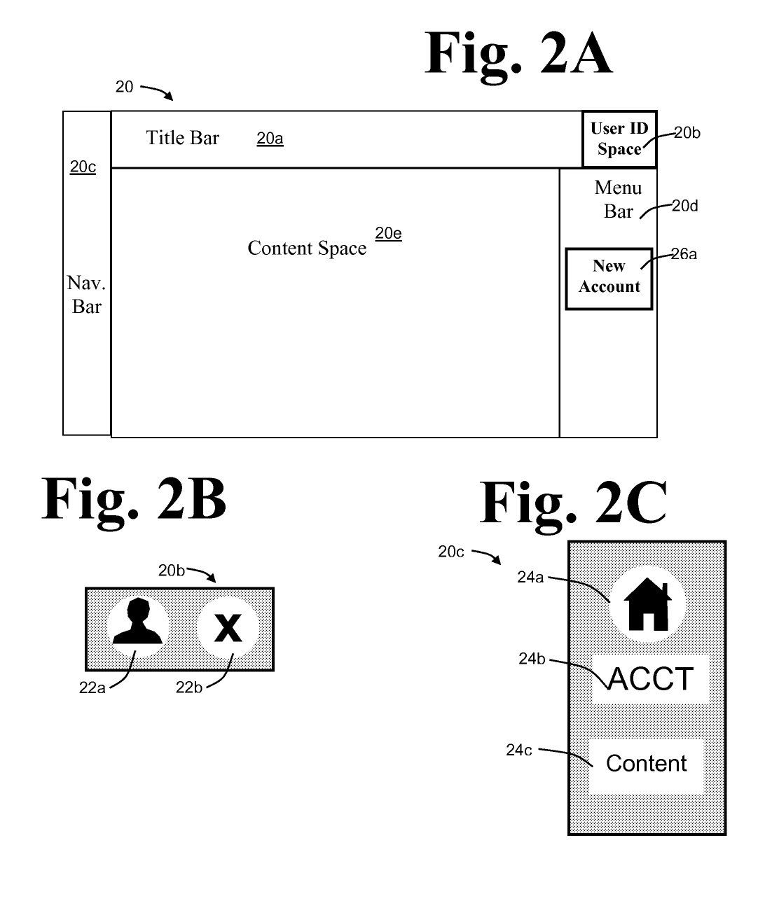

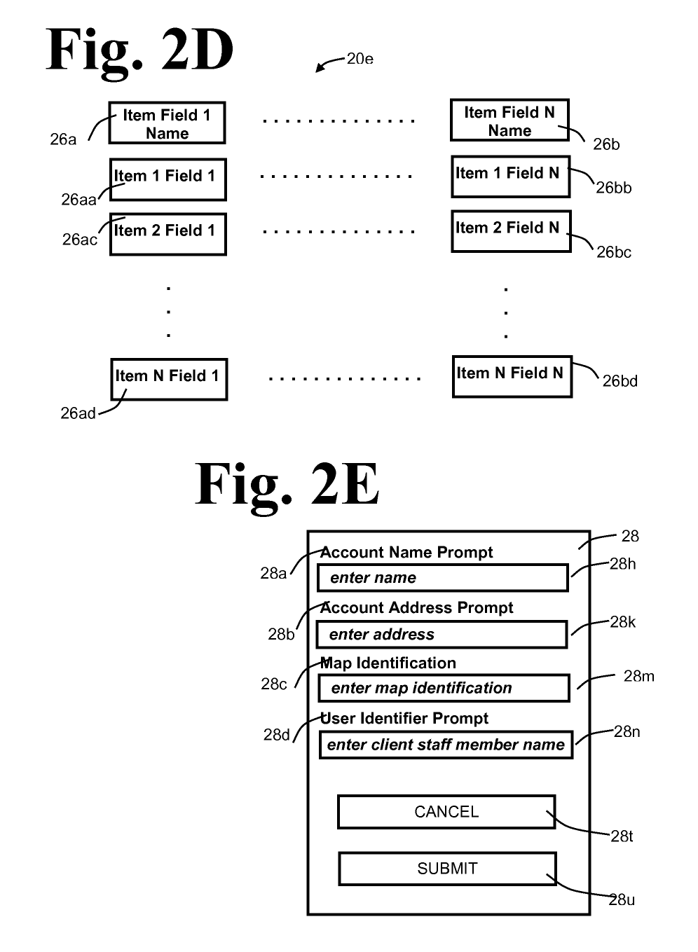

Interactive sessions for provider specialists facilitate provider specialist participation in data collection and content creation and revision. Provider specialist participation in interactive sessions may be initiated from provider user device 12. Displays are presented at a display screen of an interface device such as display screen 12e and provider specialist interactions are effected with a keyboard such as keyboard 12f and a pointing device such as pointing device 12g. An interactive session of a provider specialist begins with login at the provider's website from provider interface device 12d. Provider specialist login is achieved by entry of a provider specialist user name and password in the conventional manner. Upon verification of the provider specialist's login credentials by emergency preparedness programs 16, a provider specialist interactive session is commenced. A template of a display presented at provider interface device 12d following login is illustrated in FIGS. 2A-2C. In general, content of displays presented is determined according to the role of the credentialed user. Hence, displays presented to a provider specialist may have content different from displays presented to client staff members and displays presented to client staff members may have differences in content according to the role assigned to the client staff member. The template of FIGS. 2A-2C is common for provider specialist interactive sessions for data collection, module creation and editing, and emergency response supplemental document creation and editing, collectively, content creation. FIG. 2A depicts template 20 defining common aspects of displays presented to a provider specialist engaged in an interactive session. Particular content of sections of template 20 are determined according to the nature of the interactive session in which the provider specialist is engaged. In particular: title bar 20a contains information including the name of the provider specialist; User ID Space contains active button 22a to access user profile information and active button 22b to exit (terminate) the current interactive provider specialist session. Navigation bar 20c contains active icons including Home icon 24a to cause presentation of a landing screen that is presented immediately after successful login of a provider specialist; Account icon 24b that effects presentation of information and facilities for adding and modifying client organization accounts within content space 20e, for example account records as represented by FIG. 2D and a new account pop-up menu as represented in FIG. 2E; and Content icon 24c that will initiate presentation of a display used for content creation and modification. Menu bar 24d presents active button displays for selection of menus according to the current activity. For example, in the case of presentation of an account list, menu bar 24d would present active button display 26a for creation of a new client account. As used herein, the term “account” refers to information characterizing a subscriber organization, that is, the information a provider relies on to identify a subscriber organization.

### Client Staff Members

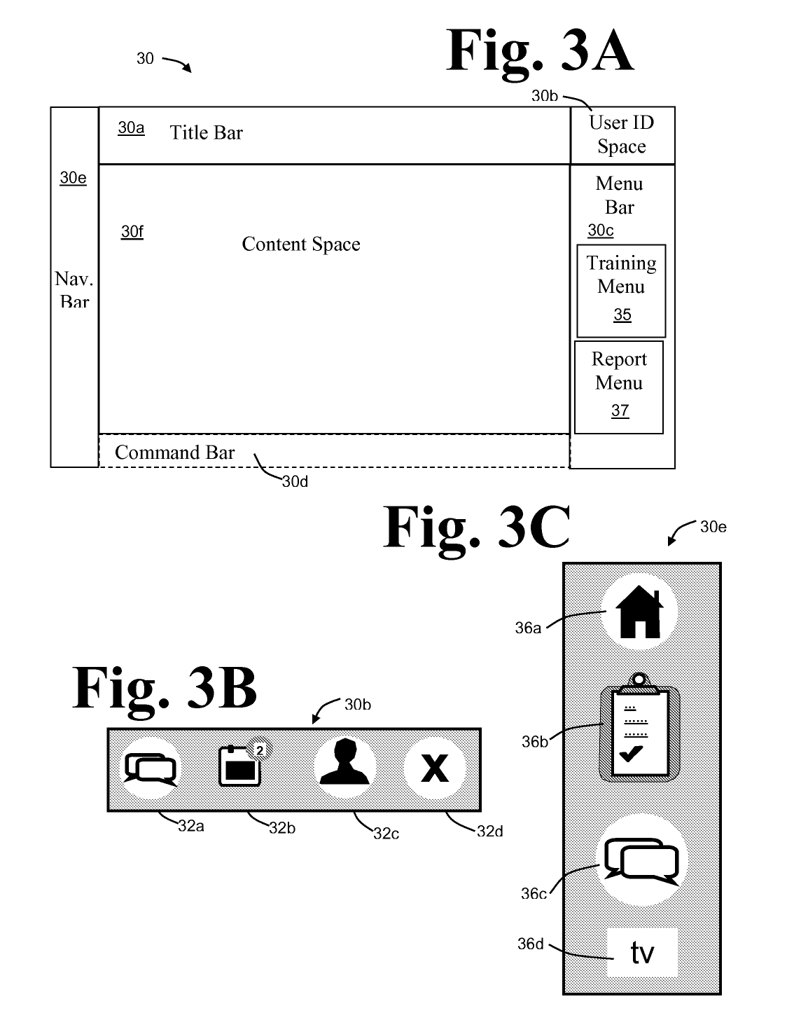

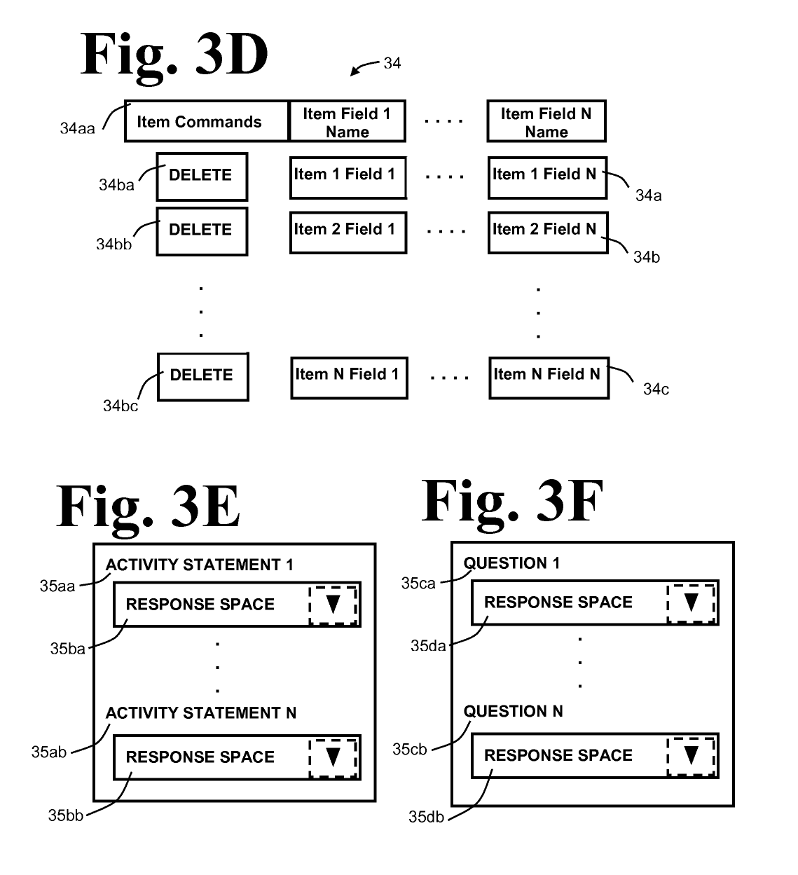

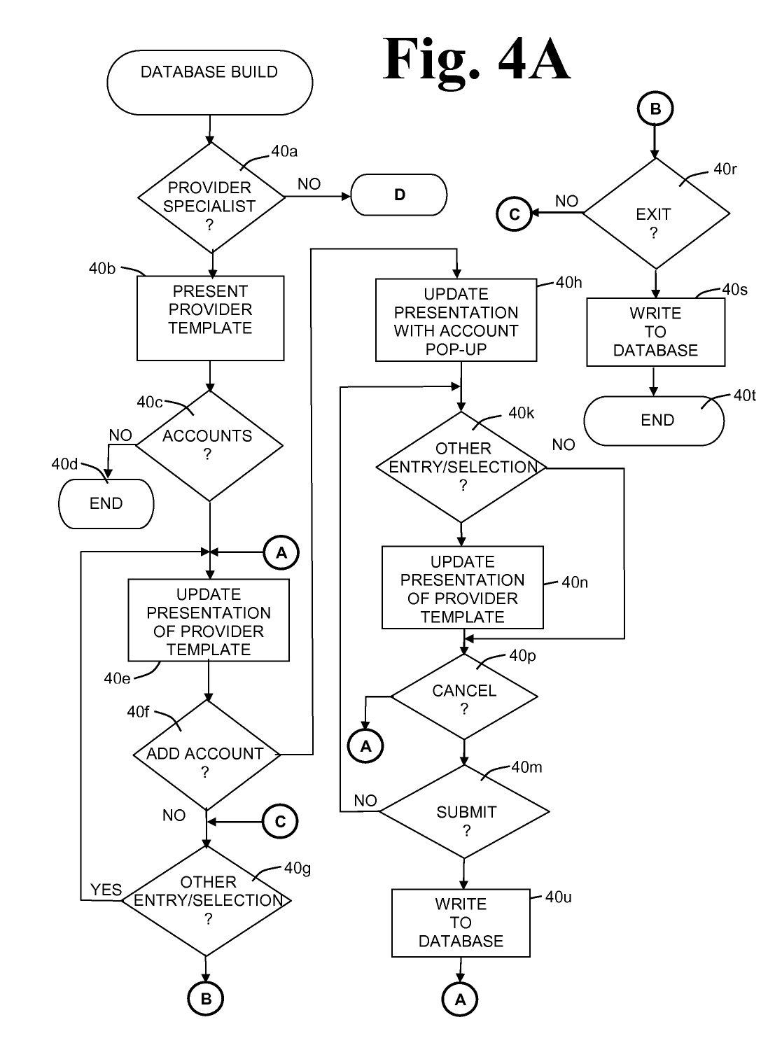

Interactive sessions of client staff members facilitate participation in: data collection; emergency response training; and provider led presentations and demonstrations. Client staff member participation in interactive sessions from client user device 10 is advantageously effected through client user interface device 10d. Displays are presented at display screen 10e and client staff member interactions are effected with keyboard 10f and pointing device 10g. An interactive session of a client staff member begins with client staff member login to the provider website from user interface 10d. Client staff member login is achieved by entry of a client staff member username and password in the conventional manner. Upon verification that the client staff member has credentials to interact with the provider website, an interactive session is commenced. As used herein, the term “credentials” shall mean the combination of a username and password together with any additional information concerning the client staff member that relates to access and use of the emergency preparedness programs, such as the client staff member position in the client organization (administrator, facility supervisor, general staff, etc.). A template of a display presented at user interface device 10d following client staff member login is illustrated in FIGS. 3A-3C. The template of FIGS. 3A-3C is common for user interactive sessions for data collection and client staff member training. In FIG. 3A, user interactive session template 30 comprises: title bar 30a; user identification space 30b; menu bar 30c; command bar 30d (presented according to the role of the client staff member); navigation bar 30e; and content space 30f. In the initial display presented after login, content of title bar 30a reflects the nature of the current display content, such as a welcome screen. User identification space 30b contains the client staff member name and selection “buttons” for selection of supplemental information relating to the client staff member and to cancel the interactive session. Menu bar 30c contains selectable “buttons” to initiate presentation of particular training modules and particular certification courses. Command bar 30d is associated with presentations of the client staff member template peculiar to a user identified as an administrator. Navigation bar 30e contains selectable (active) “buttons” for initiating certain activities from the current interactive session. FIG. 3B illustrates selectable buttons presented in user identification space 30b such as: a provider help chat icon 32a for initiating on-line support from the provider; a user notification icon 32b for initiating presentation of notifications directed to the client staff member, the notification icon including a numeric indicator reflecting the number of pending notifications directed to the client staff member; a user profile update icon 32c for selecting presentation of client staff member profile information such as user name, facility workplace, client staff member emergency response role and client staff member contact information so as to facilitate revision of the client staff member profile information; and, an exit icon 32d for terminating the current user session. FIG. 3C illustrates selectable buttons displayed in navigation bar 30e including: so-called “home” icon 36a for selecting navigation to the provider website home page; “checklist”, icon 36b for selecting navigation to a page for printing emergency response supplemental documents such as checklists of actions to be taken in the course of responding to an emergency event; “chat” icon 36c for selecting navigation to a display for initiating a so-called “live chat” session with a provider specialist; and, “TV” icon 36d for selecting navigation to a display for participating in a provider controlled interactive presentation of content relating to emergency response preparedness and training.

Collaborative Data Collection (Facility Assessment)

As indicated, interactive sessions of both client staff members and provider specialists are effective for data collection in a collaborative manner. The collaborative approach to data collection is effective to insure up-to-date facility information and reduce the involvement of provider specialists engaged in data collection whereby costs to facility operators are reduced. Inclusion of workplace details in staff member training modules is effective to improve retention of emergency response actions through reinforcement arising from association of familiar items with procedures that lie outside a staff member's daily activities. The preferred embodiment supports a continuum of collaborative data collection effort according to the preference of the client organization. That is, an organization that prefers minimal participation in data collection by its staff members can rely on provider specialists to perform data collection for virtually all data entered to the database. Conversely, an organization that prefers maximum participation in data collection by organization staff members can realize cost savings owing to the least reliance on specialist data entry. Provider specialists will always be responsible for data entry required to establish a client organization account. To expand the extent of data collection undertaken by provider specialists, a client staff member can allow a provider specialist to use client staff member credentials to engage in an interactive session in the role of a client staff member.

Data collected in the course of the collaborative “build”, i.e., storage of information in a database such as database 16f, comprise records comprising information to characterize a client organization, client organization facilities, and client organization staff members. Information in database 16f is organized in “tables”, according to categories of information, such as: client organizations; facilities; facility characteristics; facility maps; facility safety equipment; facility security devices; client staff members; client staff member emergency response roles; training modules; certification courses; and provider staff members. Each table comprises records having predetermined information fields. As is conventional, database manager programs 16d are effective for implementing logical relationships of information within database 16f so as to enable retrieval of information from the database in combinations having predetermined relationships. For example, information relating to all staff members having workplaces at a particular facility of a particular client organization can be presented in a single report. References to “building” of a client organization database contemplate collection of data relating to a particular client organization and storage of that information in database 16f. Collaborative data collection in accordance with the invention is effective to achieve planning and training that reflects information familiar to client organization staff members and particular to the facility in which they perform and their workplaces within that facility. The invention supports collection of information pertaining to a facility including: buildings, parking facilities, roadways, grounds comprising open spaces proximate buildings and recreational areas. Data is collected comprising building details including locations of: rooms; exterior doors; interior doors; windows; skylights; stairways; elevators; alarm actuators; such as fire alarm “pulls”; emergency response equipment such as fire extinguishers, fire hoses, sprinkler systems and first aid “kits”. Additionally, data is collected comprising room details including: dimensions; exits for evacuation; fixtures and, furnishings.

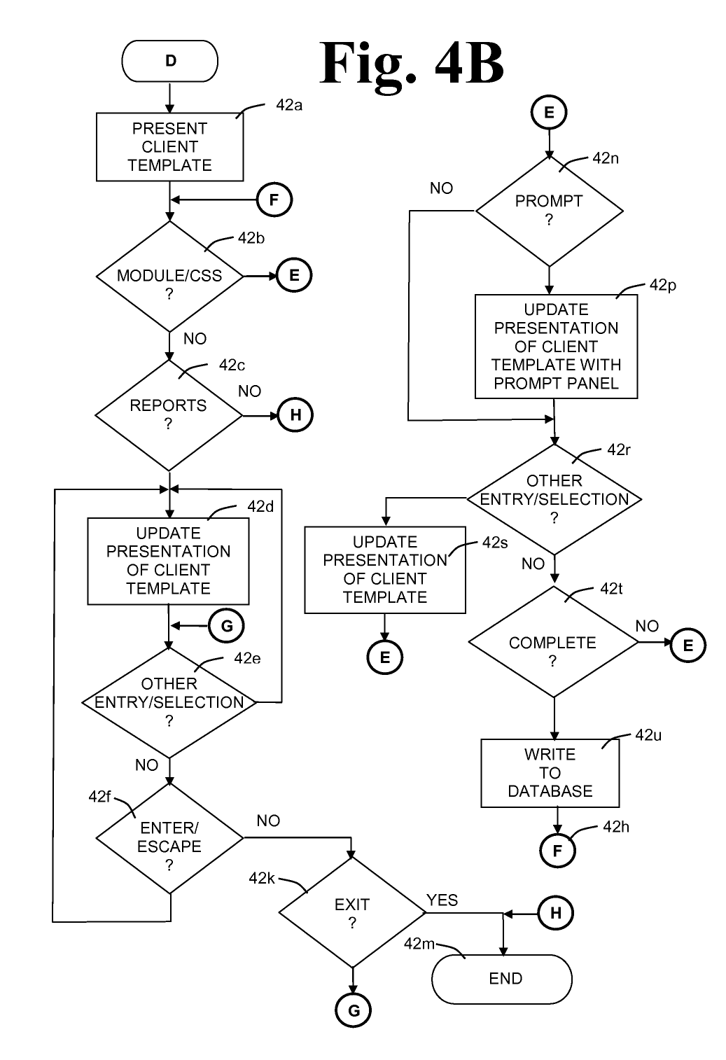

Procedures for “building” a database, i.e., for storing information in a database such as database 16f, are represented by the flow charts of FIGS. 4A and 4B. The invention contemplates that some items of information will be stored in response to interactive sessions of provider specialists while other items of information will be stored in response to interactive sessions of client organization staff members. In this approach to collaborative information storage, reliance on client organization staff reduces demand for data collection by provider specialists. Information characterizing a client organization account is stored in database 16f in response to activity by a provider specialist. Information characterizing client organization facilities and client staff members is stored in database 16f in response to activity by users identifying themselves as client staff members. In connection with establishment of a client organization account, a provider specialist identifies at least one client staff member to have credentials to enable interactive sessions by that client staff member.

FIG. 4A represents an overall procedure followed to effect data collection (information storage) relating to establishment and modification of client organization accounts. Initiation of an interactive session facilitating establishment and/or modification of client organization accounts is effected by login of a user identified as a provider specialist. Login is effected from, for example provider interface device 12d by entry of a user name and password in the conventional manner. Decision step 40a represents detection by emergency preparedness programs 16 of login by a user identified as a provider specialist. Procedure step 40b represents presentation at a user interface device such as provider interface device 12d of a provider template corresponding to the template of FIG. 2A. Decision step 40c represents detection of selection of Accounts icon 24b of FIG. 2C. If the Accounts icon is not selected, execution of the procedure of FIG. 4A is ended at terminal step 40d, reflecting that activity of the provider specialist of the current interactive session does not involve activity relating to client organization accounts. In the event Accounts icon 24b is selected, execution of the procedure of FIG. 4A continues at process step 40e reflecting presentation of client organization account records at content space 20e of FIG. 2A. FIG. 2D represents a presentation of account records wherein each field of information is identified with a field name as represented by “item field name 1” at 26a through “item field name N” at 26b indicating field names for 1 through N fields. Each account record is represented by rows of field of information from “Item 1 Field 1” at 26aa through “Item N Field N” at 26bd, the item fields 26ab, 26bb, 26ac, 26bc, 26ad and 26bd indicating fields of records presented in the account records presentation. With account records presented, a provider specialist is enabled to modify client organization account information or establish a new client organization account record. Decision step 40f represents detection of selection of the New Account menu item 26a from menu bar 20d of FIG. 2A. If New Account menu item 26a is selected, execution of the procedure of FIG. 4A continues at process step 40h where a pop-up menu display is presented enabling entry of information associated with establishment of a new client organization account. If a new client organization account is not to be created, decision step 40g represents detection of another selection or entry by emergency preparedness programs as would be associated with activity affecting account records displayed at process step 40e and the branch from decision step 40g to process step 40e represents updating of the presentation of account records according to the entry or selection detected at decision step 40g. Modifications made through selections and entries are accepted by, for example, operation of an “enter” key at keypad 12f of provider interface device 12d. Modifications that are not accepted can be replaced by the unmodified information by, for example, operation of an “escape” key at keypad 12f. Accepted modifications will be written to account records of database 16f upon exit from the current interactive session. The loop of process step 40e through decision step 40g continues with detection of entries and selections until the user selects to end the current interactive session as represented by the on-page connector “B” to decisions step 40r representing detection of user selection to exit, for example by operation of “Exit” icon 22b of FIG. 2B. In that event, entries and selections made through the procedural loop from process step 40e thorough decision step 40g are written to database 16f at process step 40s and the procedure of FIG. 4A is ended at procedure terminal 40t.

Continuing with reference to FIG. 4A, had it been determined at decisions step 40f that menu item 26a had been selected, execution of the procedure represented by FIG. 4A would continue at process step 40h where the provider template would be updated with presentation of a new account pop-up menu such as is represented by new account pop-up menu 28 at FIG. 2E. Advantageously, the new account pop-up menu presents prompts such as prompts 28a, 28b. 28c, and 28d and data entry areas such as data entry areas 28h, 28k, 28m, and 28n to allow the provider specialist to enter information associated with establishment of a new client organization account. In addition, new account pop-up menu 28 presents active “button” displays such as “Cancel” button display 28t and “Submit” button display 28u for controlling storage of information entered in database 16f. Although not shown in FIG. 2E, new account pop-up menu 28 may additionally present prompts and selection displays allowing the provider specialist to select particular characteristics to be associated with the client organization account being established. With presentation of new account pop-up menu 28, decision step 40k represents detection of an entry or selection at new account pop-up menu 28 and process step 40n represents updating of presentation of new account pop-up menu 28 with the information entered or selected. Decision step 40p represents detection of operation of “Cancel” button display 28t and on page connector “A” represents continuation of the procedure of FIG. 4A at process step 40e where the provider template is updated to eliminate presentation of new account pop-up menu 28. Data entries and selections made prior to operation of “Cancel” button display 28t are not written to database 16f in the event of operation of “Cancel” button display 28t. Decision step 40m represents detection of operation of “Submit” button display 28u and process step 40u represents writing of information to database 16f in accordance with provider specialist entries and selections made in new account pop-up menu 28 since its presentation at process step 40h until operation of “Submit” button display 28u. The loop represented by decision step 40k, process step 40n, decision step 40p and decision step 40m represents a procedure for use of new account pop-up menu 28 by which a provider specialist is able to make data entries and selections until satisfied that desired information for a new account will be added to the database by operation of “Submit” button display 28u.

Emergency preparedness programs 16 support two preferred procedures for data collection during an interactive session of a user identified as a client staff member: (i) modification of contents of predetermined reports reflecting certain categories of information associated with a client organization; and, (ii) prompted responses to queries and the like in the course of an interactive training session. These preferred procedures shall be described with reference to FIG. 4B. Had it been determined at decision step 40a of FIG. 4A that the current interactive session was not initiated by a user identified as a provider specialist, the procedure of FIG. 4B is commenced at process step 42a where, following login by a user identified as a client staff member, data preparedness programs 16 effect presentation of the user interactive session template of FIGS. 3A-3D at user interface device 10d. Decision step 42b represents detection of selection by the user from a training menu such as training menu 35 at menu bar 30c. If no such selection is made, decision step 42c represents detection of a selection by the user from a reports menu such as reports menu 37 at menu bar 30c. Without selections detected by decision steps 42b and 42c, the procedure represented by FIG. 4B is ended through on-page connector “H” at terminal 42A. Had selection been detected at decision step 42c of an item from a reports menu, execution of the procedure of FIG. 4B continues at process step 42d where the presentation of the client staff member template is updated to present content of a selected report within content space 30f. FIG. 3D represents presentation of content of a report 34 at content space 30f effected by selection from report menu 37. Report 34 comprises an array of records 34a, 34b, through 34c, each record comprising fields of items of information from Item Field 1 through Item Field N. The presentation further comprises a header row 34aa of Item Field Names from Item Field 1 Name through Item Field N Name. Report 34 further comprises presentation of a Commands column by which an action can be selected to affect any record, for example to delete a presented record as represented by Command fields 34ba, 34bb through 34bc. Decision step 42e represents detection of an entry or selection from the presentation of report 34 and the loop from process step 42d through decision step 42e represents updating the presentation of report 34 in response to entries and selections made. As is conventional, to affect information in a field, a user first selects the field using, for example a cursor controlled by a pointing device such as pointing device 10g and then enters information at the selected field using, for example, a keypad such as keypad 10f. To reject an entry made, the user may operate an escape key and data existing before modification of information in the selected field is restored to the presentation. To accept an entry made, the user may operate an enter key and presented information, including changes made in the selected field is preserved for storage in database 16f. Detection of action by the user to accept or reject an entry is represented by decision step 42f. Until the user selects to exit the procedure by, for example, selecting Exit icon 32d of FIG. 3B, the interactive procedure of modification of report information continues until detection of selection by the user to exit as represented by decision step 42k. In that event, execution of the procedure of FIG. 4B ends at terminal 42m.

Continuing with reference to FIG. 4B, had it been determined at decision step 42b that a selection was made from training menu 35, execution of the procedure of FIG. 4B would proceed at decision step 42n representing detection of arrival at a stage of a training selection from which continued progress will require prompted response by the user. Process step 42p represents updating of the user template with presentation of a pop-up prompt panel within content space 30f presenting one or more activities or inquiries requiring a user response. FIGS. 3E and 3F are examples of pop-up prompt panels, FIG. 3E representing a pop-up prompt panel associated with activities to be undertaken by the user and FIG. 3F representing a pop-up prompt panel associated with queries presented to a user. In FIG. 3E, a first activity statement 35aa recites an action to be taken by the user and the required response. Response space 35ba is provided for the user to enter the response required by activity statement 35aa. For example, the user may be directed to retrieve and enter an identification number for the building exit nearest the user's workspace. The user would enter the number at response space 35ba. Further activities may be included in a single group as represented in FIG. 3E from Activity Statement 1 through Activity Statement N (activity statement 35ab), each activity statement being associated with a response space, where response space 35bb is associated with activity statement 35ab. In a corresponding manner, in FIG. 3F a group of queries may be presented, each requiring a user response. A first question 35ca is associated with response space 35da and for each question presented to question N (question 35cb) there is an associated response space through response space 35db. A user may select response spaces using a cursor and pointing device, enter information in the response spaces and select to accept or reject entries using enter and escape keys as is conventional. Decision step 42r represents detection of selection and entries from a pop-up prompt panel and process step 42s represents updating of the client staff member display in accordance with the selections and entries within a selected pop-up prompt panel. The process of information collection in connection with pop-up prompt panels continues in a loop from process step 42r through on-page connector E until responses have been entered for all items of a pop-up prompt panel. Decision step 42t represents detection that all prompted response have been satisfied. Process step 42u represents preservation of information from a pop-up prompt panel for writing to database 16f. Thereafter execution of the procedure of FIG. 4B continues through on page connector F so as to continue progress through training. In the event of user selection to exit the current interactive session by, for example, selection of Exit icon 32d, execution of the procedure of FIG. 4B is ended through on-page connector H as herein described.

### Creation and Modification of Preparedness Material

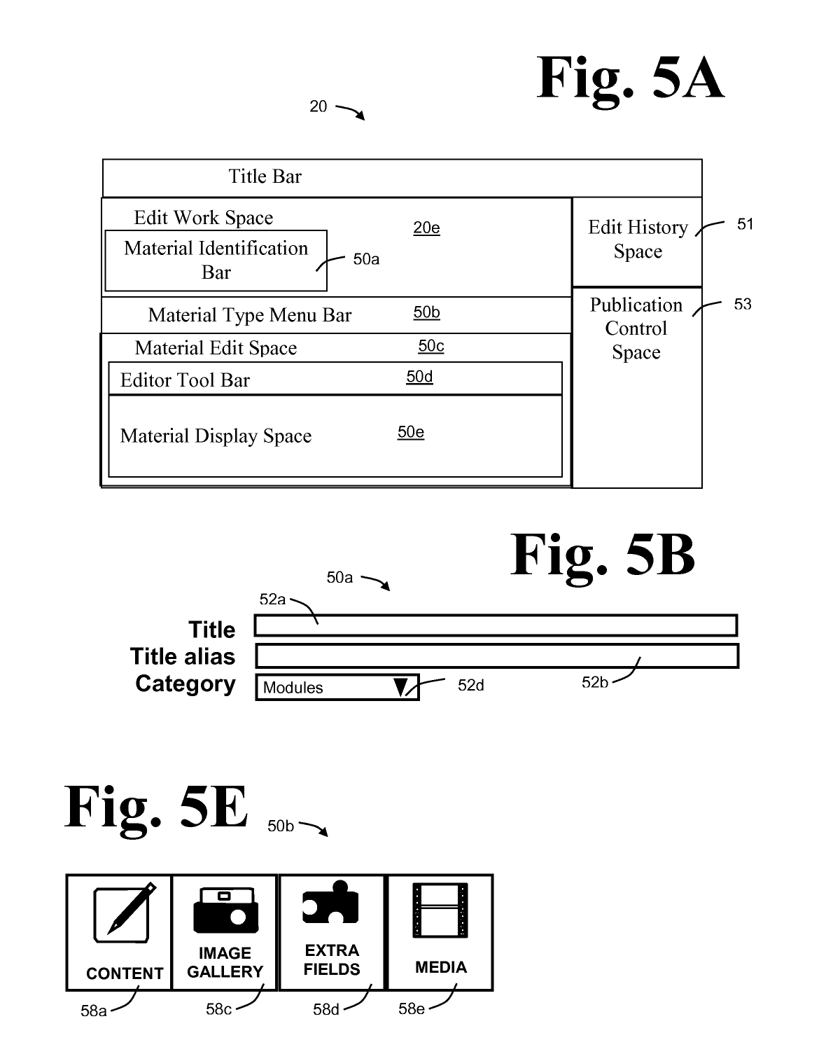

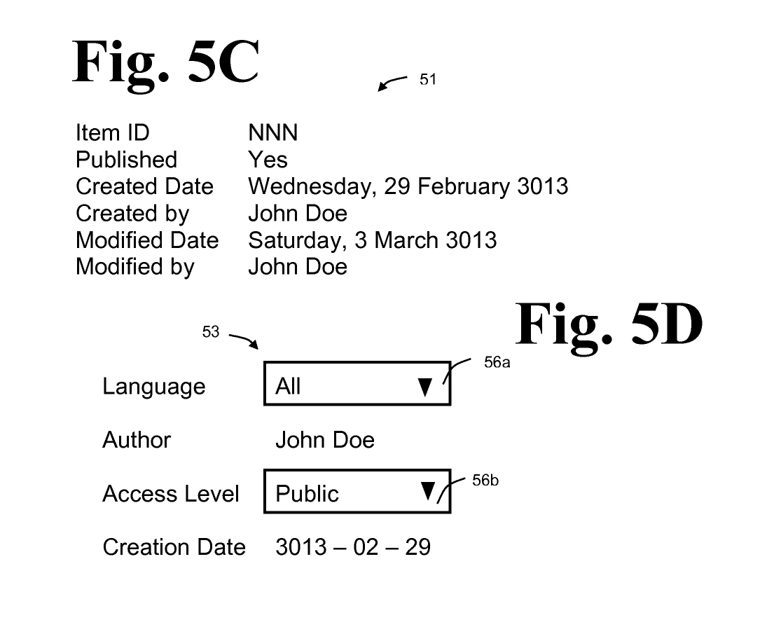

Material comprising emergency response preparedness components is created and modified by provider specialists using facilities of provider device 12 and emergency preparedness programs 16. Creation and modification of training material is based on organization of the material into training modules and certification courses. Creation and modification of supplemental documents contemplates reference material such as checklists that can be available for ready access by a client staff member engaged in execution of an emergency response. Training modules organize material into segments, each segment suitable for presentation as a webpage. Topics addressed by segments may comprise categories of introductory material, response preparation, response execution and restoration of normal operations. Description of facilities suitable for creation and modification of content comprising training modules, certification courses and supplemental documents shall be made with reference to FIGS. 5A-7e. FIG. 5A depicts appearance of the provider specialist interactive template of FIG. 2A after selection of the Content active display 24c of FIG. 2C. Edit history space 51 presents information regarding provider activity affecting the content of the current creative session, in the event the current session involves original creation of a training module, certification course or supplemental document, content of Edit History Space 51 will be determined according to the category of content being created or modified. Facilities are presented to the provider specialist in Publication Control Space 53 that allow the provider specialist to limit characteristics of publication of material being affected and access to that material. Edit Work Space is presented in content space 20e and presents facilities and tools available to the provider specialist for creation and modification of content during the current creative session, including information presented in Material Identification Bar 50a, Material Type Menu Bar 50b and Material Edit Space 50c. Editing facilities are presented in Material Edit Space 50c, including an Edit Tool Bar 50d suitable for the type of material selected from Material Type Menu Bar 50b, and Material Display Space 50e in which the material being created or revised is presented.

Continuing with reference to FIGS. 5A-5E, FIG. 5B depicts presentation of Material Identification Bar 50a including spaces for provider specialist entry of a material title at entry space 52a, and an alias for the material title at entry space 52b. The provider specialist selects the type of material being created or modified at material type selection space 52d where a scrolling device is presented to effect display of a drop-down menu of available material types, such as “module”, “certification course” or supplemental document (“checklist”). FIG. 5C illustrates edit history information 50f presented in Edit History Space 51 such as: an item number (automatically generated by emergency response preparedness programs 16 for the particular material of the current creative session); publication status of the particular material of the current creative session; date of creation of the material being created or revised in the current creative session, name of the provider specialist who created the material, last date of modification of the material; and the name of the provider specialist who last modified the material. In the event the current session is the first session for the material being created, the information presented in Edit History Space 51 will be nil until new content is written to database 16f.

Continuing with reference to FIGS. 5A-5E, FIG. 5D illustrates facilities 50g presented in Publication Control Space 53 that allow the provider specialist to limit the scope of publication of content being affected by the current creative session. Those facilities include language control space 56a in which is presented a scrolling device to effect display of a drop-down menu of available language choices such as “All”, “English”, “Spanish”, and “French”. At access control space 56b a scrolling device is presented to effect display of a drop-down menu of available access level choices such as “Public”; “Provider”, and “Provider and User Administrator”. A provider specialist selects the desired access level choice from the drop down menu presented. Access level selections are effective to block display of material to persons who are not provider specialists or who are client staff members other than certain client staff members engaged in advanced review of material.

Continuing with reference to FIGS. 5A-5E, FIG. 5E illustrates facilities presented to the provider specialist at Material Type Menu Bar 50b to allow selection of editing tools used to create and modify material. Content button display 58a allows a provider specialist to effect display of a text editor; gallery button display 58c allows a provider specialist to effect display of an image gallery from which an image may be selected; extra fields button display 58d allows a provider specialist to add types of content to be available to a client staff member engaged in a training interactive session, for example, audio, video, training activities and training questions; and, media button display 58e allows a provider specialist to select video for presentation in connection with a training module or certification course. A suitable text editor for display to a provider specialist in response to selection of content button display 58a will render content in the form and format as it will be presented in normal use, a so called What You See Is What You Get (“WYSIWIG”) rendering. Presentation of the text editor will include the associated editor tool bar 50d and display space 50e. A provider specialist uses facilities of the text editor to create and revise text that comprises a training module, certification course or supplemental document. Once created, that text is used in generation of presentations of content of a training module, certification course or supplemental document tailored to a client staff member. Selection of images enable presentation of images to tailor material to a client staff member as being particular to a user facility or the client staff member's workplaces within the user facility.

The following is an example of text comprising content that would be displayed in a text editor being used by a provider specialist:
“Welcome {“snippet” username∥} to the evacuation module for room {“snippet” profile|current room}. Our goal for this module is to make sure that you understand how to evacuate yourself and any students under your care, from room {“snippet” profile|current room} in the {“snippet” pi_field|30|building_name} building.
As you know, there are many variables that may need to be considered during any emergency situation. There is not one sole answer or response that covers all the possible scenarios and response options related to emergency evacuations. The way to prepare yourself to handle varying situations is to start with a foundation of basics, and build from there. This module is your foundation.

{“snippet” pi_map|shelter|700|20%}”

In the foregoing text, “snippet” elements appear where items of information retrieved from the database are to be inserted in text presented in content space 30f of the template of FIG. 3A. In addition a “snippet” element follows the text to effect presentation of a map image generated from information retrieved from the database and to be presented following the text in content space 30f of the template of FIG. 3A. The “snippet” elements conform to syntax recognized by emergency preparedness programs 16 to effect identification and retrieval of material comprising data, text or images from the database that is to be combined with other content to be presented to a client staff member engaged in an interactive session. In the forgoing example, “snippets” are effective to result in presentation to a client staff member of the text together with the user's name, the user's current room, facility building identification of the client organization facility where the user's current room is located, and a map presenting, for example, location of the user's current room, location of an exit to be used to evacuate the user's current room, and a path from the user's current room to the exit. The expression “user's current room” reflects ability to associate a client staff member with more than one workplace in a facility and to identify any of those workplaces as the workplace designated by the client staff member as being the workplace for the current interactive session. Overall, content comprising training material and related supplemental documents comprises text that is common without reference to a particular client organization, client facility, or client staff member. Emergency response preparedness programs 16 effects combination of that text with information retrieved from database 16f as identified by “snippets” that are contained in the common text. By this approach, content can be created that is universal for emergency response training material and for supplemental documents and use that content in combination with data collected and stored in database 16f to tailor content of training material and related supplemental documents to the particular client organization staff member engaged in interactive training.

### User Training

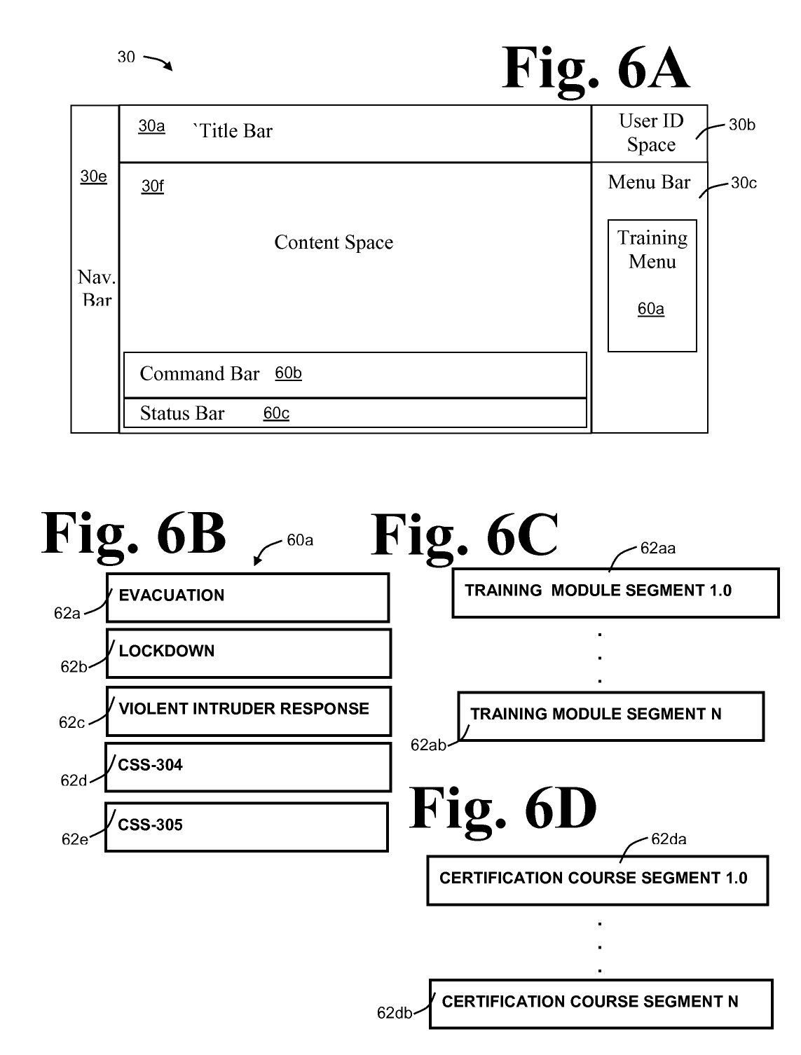

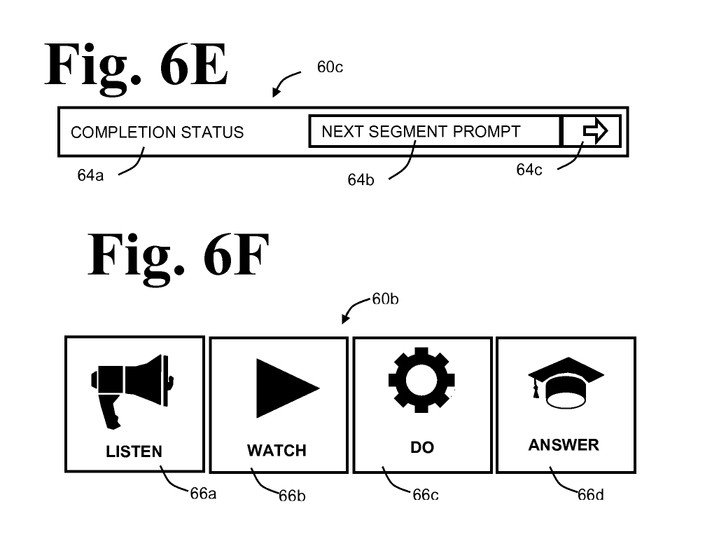

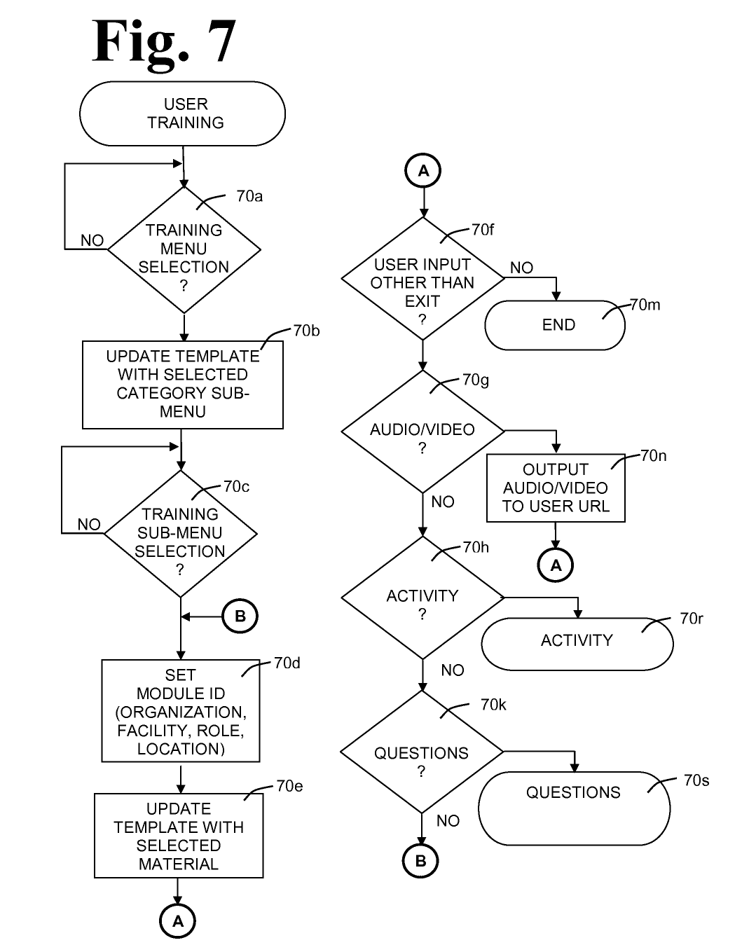

As used in the following description of FIGS. 6A-8f and 9a-9c, acts of a user of user interface device 10d that involves positioning of a display cursor and operating a switch of pointing device 10g shall be referred to as “selecting”, and the choice made by such acts shall be referred to a “user selection” or “selection”. As is conventional, such acts may result in modification of content of presentations to the user and/or progress through training material so as to effect presentation of segments of training material as chosen by the user. Content of displays presented to a client staff member engaged in an interactive session for training shall be described with reference to FIGS. 6A-6F. Referring to FIG. 6A, title bar 30a contains a title for each particular display called for by user selections. As noted with reference to FIG. 3A, user identification space 30b presents the staff member user name and client organization logo. A top level training menu 60a is presented in menu bar 30c. Content space 30f of template 30 is used for presentation of content including text, images, and video as determined by the client staff member engaged in an interactive training session. Content presented in content space 30f of the initial presentation after successful login includes introductory information relating to user training. Content presented in content space 30f of subsequent selections of the client staff member pertain to particular emergency responses for the particular user at a particular location of a particular client organization facility. A user effects such subsequent selections through menus presented in menu bar 30c and drop down menus and display panels presented in content space 30f. As is conventional, selection of an item in menu bar 30c may result in presentation of menu choices associated with the menu item selected rather than presentation of different information in content space 30f. For example, selection from the top level training menu 60a will effect presentation of a so-called “drop-down” menu of training modules and certification courses associated with the particular selection from the top level training menu. Command bar 60b presents active icons enabling user selection of supplemental items for presentation at user interface device 10d such as audio and video material as well as for displays for initiating client staff member activities relating to the selected training material and for initiating presentation of questions relating to the selected training material. Status bar 60c presents an indication as to whether or not the client staff member has completed presentation of all content available for the selected training material and an active display for selecting a training material segment, if any, that follows in the order of available training material for the selected top level of training material.

Contents of displays presented in menu bar 30c, command bar 60b and status bar 60c of FIG. 6A shall be described with reference to FIGS. 6B-6F. FIG. 6B illustrates a top level training menu 60a presented in menu bar 30c. Training menu selections include active displays for selection training modules for emergency response such as: Evacuation menu item 62a; Lockdown menu item 62b; and, Violent Intruder Response menu item 62c. The top level training menu also includes certification course active displays for selection of certification courses such as CSS-304 item 62d and CSS-305 item 62e. In response to user selection of one of the menu items of FIG. 6B, emergency preparedness programs 16 effect presentation of an associated drop down menu within content space 30f. Examples of presentation of drop-down menus facilitating user selection of training material are illustrated in FIGS. 6C and 6D. FIG. 6C represents a drop down menu of training module segments associated with the selection of one of training material items 62a-62c of FIG. 6B. Menu items of the drop down menu of FIG. 6C present selectable active displays of all segments of training modules associated with the selected emergency response, ranging from a first training module segment active display 62aa through the Nth training module segment active display 62ab. In response to selection of one of the active displays of FIG. 6C, emergency response preparedness programs 16 effect presentation of content for the selected module at content space 30h. In a like manner, FIG. 6D represents a drop down menu of certification course segments associated with selection of one of the certification course active displays 62d and 62e of FIG. 6B. Segments of certification courses are advantageously identified by particular subject matter required for the selected certification. In FIG. 6D, active displays of certification course segments from a first segment through an Nth segment are represented by active displays 62da and 62db. In response to selection of one of the active displays of FIG. 6D, emergency response preparedness programs 16 effect presentation of content for the selected certification course segment at content space 30f.

Continuing with reference to FIGS. 6E and 6F, contents of status bar 60c are represented by FIG. 6E. In FIG. 6E, a status of completion by the client staff member of the currently selected training material is represented by completion status 64a. An example of completion status would be: “YOU HAVE COMPLETED THIS MODULE”. In addition to presentation of completion status, if complete and if there are additional segments comprising the selected training material, a next segment prompt 64b is presented together with an active display 64c for selecting the training material segment identified in the prompt. For example, the prompt may be: “GO TO MODULE N.N” and, in response to client staff member selection of active display 64c, emergency preparedness programs 16 effect presentation of the identified training material segment at content space 30f. FIG. 6F illustrates icons presented at command bar 60b including: “listen” icon 66a for client staff member initiation of an audio presentation; “watch” icon 66b for client staff member initiation of a video presentation; “do” icon 66c for client staff member initiation of display of an activity pop-up prompt panel associated with particular actions to be taken by the user and relating to the training material being presented; and, “answer” icon 66d for client staff member initiation of display of a pop-up prompt questions panel enabling a client staff member to respond to questions relating to the particular segment of training material being presented. As noted herein these pop-up prompt panels are used in connection with collection of information that is written to the database and is used in subsequent presentation of training material.

Continuing with reference to FIG. 6A, tailoring of training modules for client staff members is effective to present material in content space 30f that is particular to a client staff member. Tailoring of training module content is advantageously implemented using executable programming elements such as so-called “snippets” embedded in HTML text created for presentation in content space 30h. Each “snippet” effects presentation of material particular to a client staff member and retrieved from the database together with predetermined text comprising training content of a selected training module. For example, training module predetermined text is written with embedded “snippets” associated with a client organization name, a facility name, and a client staff member name. When that training module is selected by the client staff member from a menu presented in a drop down menu such as illustrated in FIG. 6C, emergency preparedness programs 16 effect, retrieval of the items from the database associated with the “snippets” and presentation of those items together with the predetermined training module content so that each of the retrieved items replaces the associated “snippet” as the training module content is presented. A “snippet” may include elements indicating the nature of the item to be inserted, the source from which the inserted material is to be retrieved and characteristics determining formatting and location within content space 30f of the material to be inserted. Further, a “snippet” may be used to insert not only text but images. Hence, training module text can be presented with an image of a client staff member workplace, facility, a facility map, a facility structure, a facility structure floor plan, a facility grounds area or other landmark all of which will be familiar to the client staff member.

A procedure implemented by emergency preparedness programs 16 for effecting interactive training is illustrated by the flow chart of FIG. 7. Client staff member training is initiated by a client staff member connecting to the provider web site and entering, through a presentation of a conventional “login” screen, a user name and password. In response to receipt of the user name and password information, emergency preparedness programs 16 compare the entered information to existing records of credentialed users to confirm that the client staff member is recognized by the provider. In the event the entered information is not confirmable, emergency preparedness programs 16 effect presentation of prompts to the user that allow the user to retry login or proceed to an alternative login procedure by which a credentialed user may be recognized. Once a user has successfully logged in, emergency preparedness programs 16 effect presentation of displays on user interface device 10d that conform substantially to template 30 illustrated in FIGS. 6A-6F. Following client organization staff member login, a user makes a training menu selection from a training menu such as training menu 60a presented in menu bar 30c. Decision step 70a represents detection of occurrence of a user selection from training menu 60a. At procedure step 70b, a sub-menu for the selected category of training material selected from the menu of FIG. 6B is written to the template for presentation to the client staff member. Decision step 70c represents detection by emergency preparedness programs 16 of a selection of training material from the sub-menu presented at procedure step 70b. At procedure step 70d, identifying information associated with the client organization, facility, client staff member role and workplace location and the training material selected from the training material sub-menu is set to select a particular training material segment. Procedure step 70e represents updating of the template with content of the selected training material segment together with data retrieved in response to “snippets” embedded in that training material segment. With selected training material now presented at user interface device 10d, emergency preparedness programs 16 await input from the client staff member according to selections available from the template.

Continuing with reference to FIG. 7, decision steps 70f through 70k represent detection of a client staff member selection. Detection of selection by the client staff member of an “exit” active display, such as exit active display 32d of FIG. 3B, is represented by decision step 70f. The current interactive training session is then ended at terminal 70m. Detection of selection by the client staff member of an active icon for initiation of presentation of audio or video material, such as icons 66a and 66b of FIG. 6F is represented by decision step 70g. In the event more than one audio or video presentation is associated with the currently selected training material, a display panel for selection from the available items would be presented and the selection from that panel by the client staff member would result in output of the selected audio or video item to user interface device 10d by emergency response programs 16 at procedure step 70n. Detection of selection by the client staff member of an active icon for initiation of an activity, such as “do” icon 66c of FIG. 6F, is represented by decision step 70h and emergency preparedness programs 16 continue through activity terminal 70r to present the pop-up prompt panel as described with reference to FIG. 4B. Detection of selection by the client staff member of a questions active icon for initiation of questions associated with the currently active training material, such as “answer” icon 66d of FIG. 6F, is represented by decision step 70k and emergency preparedness programs 16 continue through review questions terminal 70s to present the questions pop-up prompt panel as described with reference to FIG. 4B. Had the client staff member selected another segment of training material from active display 64c of FIG. 6E upon completion of the currently selected training material, emergency preparedness programs would continue through “B” terminals to effect presentation of the next segment of training material together with information particular to the client staff member.

### Labeling

Client staff member training is advantageously enhanced with use of preprinted labels prepared by the provider. Labels are applied to certain Items of a user facility that are included in the client organization database for the facility. For example, a label can be applied to designate each room and each doorway to be represented in a facility database. Labels can be applied by either provider specialists or client staff members. Labels advantageously contain identifying information such as a number code. Most advantageously, labels can include an image suitable for optical scanning, such as a quick response bar code matrix so-called “QR code”. For such labels, information included in QR code encoding identify the client organization facility, an item category and the provider URL. Once in place, client staff member training can include interactive exercises in which a user enters information found on a label or uses a portable user device to scan the label QR code. The encoded information of the QR code is then forwarded to the provider URL and emergency preparedness programs 16 process the information for inclusion with information in database 16f characterizing a client organization facility.

What is claimed is:

1. An apparatus for emergency response preparedness comprising:
a. at least one program controlled device comprising a display device with associated data entry device and pointing device, a data processor and memory;
b. operating programs stored in the memory for controlling operation of components of the program controlled device and controlling execution of application programs;
c. database application programs for program controlled management of a database of stored information for characterizing client organizations, client facilities, and client staff members;
d. emergency response preparedness application programs for computer aided: collection of information to be stored in the database; interactive emergency response training; and interactive creation of content of emergency response training material and related documentation wherein content of training material and related documentation presented to a client staff member engaged in interactive training is tailored to the client staff member in accordance with information stored in the database.

2. The apparatus according to claim 1 wherein information stored in the database characterizing:
a. client organizations comprises:
i. client organization names;
ii. client organization addresses;
iii. client facilities identification; and,
iv. client staff members identification;
b. client facilities comprises:
i. facility components comprising structures and grounds;
ii. facility structure rooms, hallways, stairways, exits, windows, emergency alarm devices, emergency equipment comprising fire extinguishers, emergency medical equipment, sprinkler systems, security devices, and public address equipment; and
c. client staff members comprises:
i. staff member credentials;
ii. staff member workplaces; and,
iii. staff member emergency response roles; and
d. material presented to a client staff member engaged in interactive training is tailored to the client staff member according to the client staff member credentials, the facility in which the client staff member's workplace is located, the client staff member's workplace and the client staff member's emergency response role.

3. The apparatus according to claim 1 wherein the emergency preparedness application programs enable a provider specialist to establish credentials for at least one client organization staff member to engage in interactive sessions under control of the emergency response preparedness programs.

4. The apparatus according to claim 3 wherein the emergency preparedness application programs enable a credential client organization staff member to establish credentials for other client organization staff members to facilitate their participation in interactive sessions under control of the emergency preparedness programs.

5. The apparatus according to claim 1 wherein the emergency response preparedness application programs support collaborative data collection by client organization staff members and provider organization specialists.

6. The apparatus according to claim 5 wherein the collaborative procedure for data collection enables a provider specialist to establish credentials for at least one client organization staff member to facilitate access by the client organization staff member to engage in interactive sessions involving data collection under control of the emergency response preparedness programs.

7. The apparatus of claim 1 wherein the program controlled devices further comprise:
a. at least one user program controlled device comprising a display device with associated data entry device and pointing device, a data processor, a data communication interface and memory in which are stored operating programs for controlling operation of components of the user program controlled device and execution of application programs;
b. a server program controlled device comprising a data processor, a data communications interface and memory in which are stored operating programs for controlling operation of components of the server program controlled device and application programs comprising the database application programs and the emergency response preparedness application programs; and the apparatus further comprises:
c. data communication means for providing data communication between user program controlled devices and the server program controlled device so as to effect interactive data collection by users and interactive training by client staff members.

8. The apparatus according to claim 7 wherein the communications means comprises a network of interconnected networks such as the Internet, the user program controlled devices comprise so called browser programs for communication via the internet and the server program controlled device comprises website support programs enabling operation of a provider website for enabling access from user program controlled devices to facilities of the emergency preparedness application programs.

9. The apparatus according to claim 8 wherein information stored in the database characterizing:
a. client organizations comprises:
i. client organization names;
ii. client organization addresses;
iii. client facilities identification; and,
iv. client staff members identification;
b. client facilities comprises:
i. facility components comprising structures and grounds;
ii. facility structure rooms, hallways, stairways, exits, windows, emergency alarm devices, emergency equipment comprising fire extinguishers, emergency medical equipment, sprinkler systems, security devices, and public address equipment; and
c. staff members comprises:
i. staff member credentials;
ii. staff member workplaces; and,
iii. staff member emergency response roles; and
d. material presented to a client staff member engaged in interactive training is tailored to the client staff member according to the client staff member credentials, the facility in which the client staff member's workplace is located, the client staff member's workplace and the client staff member's emergency response role.

10. The apparatus according to claim 9 wherein the user program controlled devices include at least one client user program controlled device and at least one provider user program controlled device, the client user program controlled device being available to at least client organization staff members and the provider user program controlled device being available to provider organization specialists.

11. A method for computer aided emergency response preparedness wherein at least one program controlled device comprises a display device with associated data entry device and pointing device, a data processor and memory in which are stored operating programs for controlling operation of components of the program controlled device and for controlling execution of application programs, and the method comprises:
a. execution of database application programs for program controlled management of a database of stored information characterizing client organizations, client facilities and client staff members; and
b. execution of emergency response preparedness application programs for computer aided: collection of information to be stored in the database; interactive emergency response training; and interactive creation of content of emergency response training material and related documentation wherein content of training material and related documentation presented to a client staff member engaged in interactive training is tailored to the client staff member in accordance with information stored in the database.

12. The method according to claim 11 wherein execution of the emergency preparedness application programs is effective to store information in the database characterizing:
a. client organizations comprising:
i. client organization names;
ii. client organization addresses;
iii. client facilities identification; and,
iv. client staff members identification;
b. client facilities comprising:
i. facility components comprising structures and grounds;
ii. facility structure rooms, hallways, stairways, exits, windows, emergency alarm devices, emergency equipment comprising fire extinguishers, emergency medical equipment, sprinkler systems, security devices, and public address equipment; and
c. client staff members comprising:
i. staff member credentials;
ii. staff member workplaces; and,
iii. staff member emergency response roles; and
d. material presented to a client staff member engaged in interactive training is tailored to the client staff member according to the client staff member credentials, the facility in which the client staff member's workplace is located, the client staff member's workplace and the client staff member's emergency response role.

13. The method according to claim 11 wherein the emergency preparedness application programs enable a provider specialist to establish credentials for at least one client organization staff member to engage in interactive sessions under control of the emergency response preparedness programs.

14. The method according to claim 13 wherein the emergency preparedness application programs enable a credential client organization staff member to establish credentials for other client organization staff members to facilitate their participation in interactive sessions under control of the emergency preparedness programs.

15. The method according to claim 11 wherein the emergency response preparedness application programs support collaborative data collection by client organization staff members and provider organization specialists.

16. The method according to claim 15 wherein the collaborative procedure for data collection enables a provider specialist to establish credentials for at least one client organization staff member to facilitate access by the client organization staff member to engage in interactive sessions involving data collection under control of the emergency response preparedness programs.

17. The method of claim 11 wherein the program controlled devices further comprise:
a. at least one user program controlled device comprising a display device with associated data entry device and pointing device, a data processor, a data communication interface and memory in which are stored operating programs for controlling operation of components of the user program controlled device and execution of application programs;
b. a server program controlled device comprising a data processor, a data communications interface and memory in which are stored operating programs for controlling operation of components of the server program controlled device and application programs comprising the database application programs and the emergency response preparedness application programs; and the apparatus further comprises:
c. data communication means for providing data communication between user program controlled devices and the server program controlled device so as to effect interactive data collection by users and interactive training by client staff members, the communications network comprising a network of interconnected networks such as the Internet and
d. execution of application programs of the user devices enables communication via the Internet; and
e. execution of application programs of the server controlled device supports operation of a provider website for enabling access to facilities of the emergency response preparedness programs via the Internet.

18. The method according to claim 17 wherein information stored in the database characterizing:
a. client organizations comprises:
i. client organization names;
ii. client organization addresses;
iii. client facilities identification; and,
iv. client staff members identification;
b. client facilities comprises:
i. facility components comprising structures and grounds;
ii. facility structure rooms, hallways, stairways, exits, windows, emergency alarm devices, emergency equipment comprising fire extinguishers, emergency medical equipment, sprinkler systems, security devices, and public address equipment; and
c. staff members comprises:
i. staff member credentials;
ii. staff member workplaces; and,
iii. staff member emergency response roles; and
d. material presented to a client staff member engaged in interactive training is tailored to the client staff member according to the client staff member credentials, the facility in which the client staff member's workplace is located, the client staff member's workplace and the client staff member's emergency response role.

19. The method according to claim 18 wherein the user program controlled devices include at least one client user program controlled device and at least one provider user program controlled device, the client user program controlled device being available to at least client organization staff members and the provider user program controlled device being available to provider organization specialists.
